(19) United States
(12) Patent Application Publication
(10) Pub. No.: US 2009/0075848 A1
(43) Pub. Date: Mar. 19, 2009

(54) ENVIRONMENTALLY COMPATIBLE DEFOAMING COMPOSITION FOR USE IN FLUIDS

(75) Inventors: Jim Patrick Arduino, Smyrna, GA (US); Charles Theodore Gammon, Kennesaw, GA (US)

Correspondence Address: CANTOR COLBURN, LLP, 20 Church Street, 22nd Floor, Hartford, CT, 06103, US

(73) Assignee: KEMIRA CHEMICALS INC., Kennesaw, GA (US)

(21) Appl. No.: 12/209,263

(22) Filed: Sep. 12, 2008

Related U.S. Application Data
(60) Provisional application No. 60/972,474, filed on Sep. 14, 2007.

(51) Int. Cl. C09K 8/48; E21B 33/13

(52) U.S. Cl. 507/260; 166/294

(57) ABSTRACT

Defoaming compositions for reducing the amount of gas present in a fluid such as a cement composition are provided. In an embodiment, a defoaming composition includes a carboxylic acid compound or an ester of a carboxylic acid compound; an alpha olefin compound; and an alcohol compound.

### CROSS REFERENCE TO RELATED APPLICATION

This application claims the benefit of U.S. Provisional Patent Application No. 60/972,474 filed Sep. 14, 2007, which is incorporated by reference herein in its entirety.

### BACKGROUND

The present disclosure generally relates to defoaming compositions, and more particularly, to environmentally compatible defoaming compositions for reducing the amount of gas present in a fluid such as a cement composition.

Well cementing is a process used in penetrating subterranean formations to recover subterranean resources such as gas, oil, minerals, and water. In well cementing, a well bore is drilled while a drilling fluid is circulated through the wellbore. After the drilling is terminated, a string of pipe, e.g., casing, is run in the wellbore. Primary cementing is then typically performed whereby a cement slurry is pumped down through the string of pipe and into the annulus between the string of pipe and the walls of the wellbore to allow the cement slurry to set into a hard mass and thereby seal the annulus. Subsequent secondary cementing operations may also be performed. One example of a secondary cementing operation is squeeze cementing whereby a cement slurry is forced under pressure to areas of lost integrity in the annulus to seal off those areas.

During the preparation of and/or pumping of the cement slurry, gas can become entrained in the slurry. The presence of excessive entrained gas in the cement slurry can undesirably compromise the strength of the ensuing cement. As a result, the hardened cement can fail to adequately support the string of pipe and the walls of the wellbore.

Defoaming compositions have been used in the oil and gas industries to prevent or reduce the formation of foam or the entrainment of gas in well treatment fluids such as cement slurries, oil field drilling muds, oil and gas separation processes, and the like. They provide for better control over the density of the hardened cement that is formed. They have also been used to destroy or “break” previously formed foam in a fluid. For example, a defoaming composition can be added to a well treatment fluid containing foam to break the foam, allowing the fluid to be disposed of more easily.

Defoaming compositions also have been used in several other industries to reduce the amount of gas entrained in various fluids required by those industries. These applications include, but are not limited to, waste treatment, water treatment, mining, pulp and paper, paper machines, paper coating, latex stripping processes, and various coating applications, and the like.

Various types of defoamers are currently available. For example, polysiloxane (silicone) emulsions have been used as defoamers. Other types of defoamers include hydrophobic silica, tributyl phosphate, acetylenic diol, polypropylene glycol, and a mixture of polypropylene glycol with a copolymer of ethylene oxide and propylene oxide monomers.

### BRIEF SUMMARY

Disclosed herein are defoaming compositions, end use materials comprising the same, methods for reducing the amount of gas present in a fluid, and methods for making a cement composition. In an embodiment, a defoaming composition comprises: a carboxylic acid or an ester of a carboxylic acid; an alpha olefin; and an alcohol, an ethoxylate, alkoxylate, or propoxylate of an alcohol, or an ester of an alcohol.

In another embodiment, a method for reducing an amount of entrained gas present in a flowable end use material comprises: adding a defoaming composition to the fluid, the defoaming composition comprising: a carboxylic acid or an ester of a carboxylic acid; an alpha olefin; and an alcohol, an ethoxylate, alkoxylate, or propoxylate of an alcohol, or an ester of an alcohol.

In yet another embodiment, a method for making a cement composition comprises blending together a cementitious material, a fluid, and a defoaming composition comprising: a carboxylic acid or an ester of a carboxylic acid; an alpha olefin; and an alcohol comprising, an ethoxylate, alkoxylate, or propoxylate of an alcohol, or an ester of an alcohol.

In an additional embodiment, a method of cementing in a subterranean formation, comprises: displacing a cement composition into a subterranean formation, the cement composition comprising a carboxylic acid or an ester of a carboxylic acid, an alpha olefin, and an alcohol, an ethoxylate, alkoxylate, or propoxylate of an alcohol, or an ester of an alcohol; and allowing the cement composition to set.

The disclosure may be understood more readily by reference to the following detailed description of the various features of the disclosure and the examples included therein.

### DETAILED DESCRIPTION

Defoaming compositions are disclosed that include a carboxylic acid or an ester of a carboxylic acid, an alpha (α) olefin, and an alcohol, an ethoxylate, alkoxylate, or propoxylate of such an alcohol, or an ester of such an alcohol. As used herein, “defoaming” is defined as being capable of preventing or reducing the formation of foam or the entrainment of gas in a material.

As opposed to currently used defoamers such as tributyl phosphates. acetylenic diols silicones, mineral oils, and the like, these defoaming compositions are environmentally safe and thus meet strict environmental regulations applied in certain areas of the world. As such, these defoaming compositions can be used in highly regulated marine environments where oil drilling often occurs without being concerned that they could harm the marine life. These defoaming compositions also remain stable even when stored at relatively high temperatures, making them suitable for use in hot climates where oil drilling often occurs. Moreover, the defoaming performance of these compositions is better than that of currently used defoamers containing higher carbon number alcohols.

When compared to other defoamers that meet strict environmental regulations, the defoaming compositions described herein are relatively inexpensive and exhibit superior defoaming performance. Our best evidence that other environmentally safe defoamers are not as effective is that none are currently in use in the highly regulated North Sea. Mandates are in place in each country having drilling rights in the North Sea to replace current silicone and tributyl phosphate products with safer chemistries. Individual drilling operators can, however, justify the continued use of environmentally unfriendly defoamers by showing that the safer defoamers exhibit poor defoaming performance.

Additional advantages of the defoaming compositions described herein are that they exhibit favorable biodegradability characteristics, low accumulation rates of biological organisms, and low toxicity. In particular, the defoaming compositions can exhibit a biodegradability of greater than 70% after 28 days as determined based on OECD Test Guideline Nos. 301A and 301E, where “OECD” stands for the Organisation for Economic Co-Operation and Development. They can also exhibit a biodegradation of greater than 60% after 28 days as determined based on OECD Test Guideline Nos. 301B, 301C, 301D, 301F, and 306. Each one of the components of the defoaming compositions exhibits LC50 and EC50 toxicity values of less than 10 milligrams/Liter (mg/L) for numerous species. It is expected that the composition, when tested in a similar manner, will exhibit similar toxicities.

Examples of suitable carboxylic acids for use in the defoaming compositions include, but are not limited to, saturated C₈ to C₂₄ carboxylic acids, unsaturated C₈ to C₂₄ carboxylic acids, Cl₈ to C₅₄ polycarboxylic acids, and combinations comprising at least one of the foregoing carboxylic acids. More specific examples include, but are not limited to, oleic acid, eleadic acid, linoleic acid, linolenic acid, stearic acid, palmitic acid, lauric acid, myristic acid, butyric acid, margaric acid, gadoleic acid, erucic acid, riconoleic acid, and combinations comprising at least one of the foregoing carboxylic acids. In various embodiments, a tall oil fatty acid that includes a mixture of such carboxylic acids or an ester of the tall oil fatty acid can be used in the defoaming compositions. In additional embodiments, a fatty acid dimer, a fatty acid trimer, or esters of such fatty acids can be included in the defoaming compositions. Various mixtures of the carboxylic acids can be used.

The concentration of the carboxylic acid in the defoaming compositions can be about 5 weight (wt.) % to about 70 wt. %, more specifically about 30 wt. % to about 60 wt. %, and even more specifically about 35 wt. % to about 55 wt. %, with all weight percentages being based on the weight of the defoaming composition.

Examples of suitable alpha olefins for use in the defoaming compositions include but are not limited to alpha olefins comprising about 8 to about 36 carbon atoms, more specifically about 12 to about 18 carbon atoms, and even more specifically about 12 to about 14 carbon atoms, and combinations comprising at least one of the foregoing alphas olefins. Unlike mineral oils, alpha olefins are biodegradable and environmentally friendly.

The concentration of the alpha olefin can be about 20 wt. % to about 80 wt. %, more specifically about 20 wt. % to about 60 wt. %, and even more specifically about 20 wt. % to about 50 wt. %, with all weight percentages being based on the weight of the defoaming composition.

Examples of suitable alcohols for use in the defoaming compositions include but are not limited to alcohols comprising about 8 to about 36 carbon atoms, more specifically about 10 to about 22 carbon atoms, and even more specifically about 12 to about 14 carbon atoms, and combinations comprising at least one of the foregoing. More specific examples include C₁₂ to C₂₄ straight chain fatty alcohols, C₁₂ to C₂₄ branched chain fatty alcohols, and combinations comprising at least one of the foregoing alcohols. The alcohol can be a solid at room temperature. In this case, the amount of alpha olefin present in the defoaming composition is an amount effective to solubilize the alcohol.

The concentration of the alcohol can be about 5 wt. % to about 50 wt. %, more specifically about 15 wt. % to about 30 wt. %, and even more specifically about 10 wt. % to about 40 wt. %, with all weight percentages being based on the weight of the defoaming composition

In one exemplary embodiment, the defoaming compositions can be applied to a dry substrate such as silica, silica flour, kaoline, clay, diatomaceous earth, alumina, fly ash, finely divided carbon, or calcium carbonate. It can be combined with various fluids in this form to reduce the amount of gas present in such fluids. In an alternative embodiment, it can be introduced to various fluids or materials in its liquid form.

The defoaming compositions can be added to a fluid/material before, during, or after blending of the various components of the fluid/material. The defoaming compositions can be added as a liquid or as an emulsion as may be desired for the intended application. In one exemplary embodiment, a defoaming composition can be combined with a cementitious material and a fluid such as water to form a cement composition before or during the blending of those components. This blending can occur at the pumphead, which displaces the cement composition down through the annulus of a wellbore (i.e., the area between a pipe in the wellbore and the wall of the wellbore) wherein it is allowed to set into a hard cement. The defoaming compositions serve to prevent or reduce the formation of foam during the preparation or pumping of the cement composition. In another embodiment, a defoaming composition can be added to an already prepared cement composition before pumping the composition into a subterranean formation where it is allowed to set into a hard cement. In this case, the defoaming composition can serve to prevent or reduce the formation of foam in the cement composition as it is being pumped. In each of these embodiments, the ability of the defoaming composition to reduce the level of gas entrained in the cement composition can result in the formation of relatively strong cement that can properly support the piping in the wellbore. The defoaming composition can also be incorporated in the cement composition to help control the density of the ensuing hardened cement. In yet another embodiment, the defoaming compositions can be combined with a previously foamed wellbore treatment fluid such as a fracturing fluid to break or reduce the foam therein. Due to the removal of the foam, the wellbore treatment fluid can be readily disposed of after its use.

As mentioned above, cement compositions can include the defoaming compositions described herein, a cementitious material, and a sufficient amount of fluid to render the cement compositions pumpable. The cementitious material can include, for example, hydraulic cement comprising calcium, aluminum, silicon, oxygen, and/or sulfur, which sets and hardens by reaction with water. Examples of suitable hydraulic cements include but are not limited to Portland cements such as class A, B, C, G, and H Portland cements, pozzolana cements, gypsum cements, high alumina content cements, silica cements, high alkalinity cements, and combinations comprising at least one of the foregoing cements. Examples of suitable fluids for use in the cement compositions include but are not limited to fresh water, an unsaturated aqueous salt solution, a saturated aqueous salt solution such as brine or seawater, and combinations comprising at least one of the foregoing.

As deemed appropriate by one skilled in the art, additional additives can be added to the cement composition for improving or changing the properties of the ensuing hardened cement. Examples of such additives include but are not limited to set retarders, fluid loss control additives, dispersing agents, set accelerators, and formation conditioning agents. Other additives such as bentonite and silica fume can be introduced to the cement composition to prevent cement particles from settling to the bottom of the fluid. Further, a salt such as sodium chloride can be added to the cement composition when the drilling zone has a high salt content.

The defoaming compositions described herein can be included in various flowable end use materials to reduce the amount of entrained gas present in such materials. In addition to cement compositions, other examples of such end use materials include but are not limited to various wellbore treatment fluids such as drilling fluids, waste treatment compositions, water treatment compositions, leaching compositions for mining, pulping compositions, paper compositions, oil and gas separation compositions, and coating compositions such as paper coating compositions. The various components of such compositions would be apparent to persons of ordinary skill in the art.

The disclosure is further illustrated by the following non-limiting examples.

### EXAMPLES

Various samples of defoaming compositions were prepared as shown in Table 1. The weight percents of the different components in the defoaming composition samples are provided.

TABLE 1

| Example | | | Alpha Olefin |
|---|---|---|---|
| No. | Alcohol (wt %) | Carboxylic Acid (wt %) | (wt %) |
| 1 | Alfol 1618 (9) | SYLFAT FA-2 tall oil fatty | C-16 (86) |
| | | acid (10) | |
| 2 | Alfol 1618 (9.5) | Glycerol monostearate (5) | C-16 (85.5) |
| 3 | Alfol 1618 (7.5) | monomer fatty acid ester | C-16 (67.5) |
| | | (25) | |
| 4 | Alfol 1618 (6) | SYLFAT FA-2 tall oil fatty | C-16 (54) |
| | | acid (40) | |
| 5 | Alfol 1618 (18) | SYLFAT FA-2 tall oil fatty | C-16 (42) |
| | | acid (40) | |

Alfol® 1618 is a C-16/C-18 alcohol blend commercially available from Sasol North America Inc. The C-16 alpha olefin is commercially available from Chevron Phillips Chemical Company. The SYLFAT FA-2 tall oil is commercially available from Arizona Chemical Co.

The ability of each defoaming composition sample to reduce the amount of foam in a cement composition was tested at ambient temperature or at 100° C. in accordance with the following procedure. First, 200 grams (g) of deionized water and 100 g of a blend of two types of Portland cement were added to a blender. The blender was turned on for 15 seconds after which 0.5 milliliter (mL) of a commercially available foamer (ammonium lauryl ether sulfate) were added while continuing to blend the mixture. After blending for 15 additional seconds, 150 microliters (μL) of the defoaming composition sample were added to the mixture while still blending. After blending for 30 additional seconds, the contents of the blender were immediately transferred to a 1,000 mL graduated cylinder, and the fill level was recorded as a measure of antifoaming efficiency. The foam height was measured again after 60 seconds as a measure of defoaming efficiency. This test procedure was repeated in some cases, and the mean foam height was determined. These foam height values were compared to the foam height with no defoaming composition added (450 mL) to determine the percentage of foam eliminated by the defoaming composition sample. The results are also shown in the Table.

The foregoing test procedure was also repeated using two competitive defoamers as control samples (controls 1 and 2) and Colloids 1010, Callaway 8880, and Calmfoam 8850 defoamers sold by Kemira Chemicals, Inc. as control samples. Control 1 is a non-silicone, non-oil based defoamer commercially used in cementing operations. Control 2 is a silicone emulsion defoamer commercially used in cementing operations. Colloids 1010, Callaway 8880, and Calmfoam 8850 are silicone based defomaers commercially available from Kemira. As shown in the Table, the defoaming composition samples based on embodiments described herein performed better than the control samples at reducing the amount of foam in the cement compositions.

Additionally, as shown in Table 2, the 248-35J defoaming composition sample and the control 1 and control 2 samples were tested as described above except that the test was performed at 212° F. The 248-35J defoaming composition sample performed much better than the control samples at this temperature.

TABLE 2

| | Average Foam Height | | | % Foam |
|---|---|---|---|---|
| Example No. | Run 1 | Run 2 | Mean | Eliminated |
| Control 1 | 435 | 440 | 437.5 | 5.7 |
| Control 1 | 445 | | 445 | 2.3 |
| Colloids 1010/Callaway 8880 | 425 | | 425 | 11.4 |
| Calmfoam 8850 | 435 | | 435 | 6.8 |
| Control 1 | 430 | 430 | 430 | 9.1 |
| 1 | 395 | 405 | 400 | 22.7 |
| 2 | 427 | | 427 | 10.5 |
| 3 | 400 | | 405 | 20.5 |
| 4 | 410 | 395 | 402.5 | 21.6 |
| Control 1 | 430 | 420 | 425 | 11.4 |
| 5 | 345 | 350 | 347.5 | 46.6 |
| Control 2 | 435 | 415 | 425 | 11.4 |
| 5 | 350 | 350 | 350 | 45.5 |
| Control 2 | 400 | 395 | 397.5 | 23.9 |
| (Performed at 212° F.) | | | | |
| Control 1 | 400 | | 400 | 22.7 |
| 5 | 355 | | 355 | 43.2 |
| (Performed at 212° F.) | | | | |

The results clearly show an increase in defoaming efficiency relative to the controls.

As used herein, the terms “a” and “an” do not denote a limitation of quantity, but rather denote the presence of at least one of the referenced items. Moreover, the endpoints of all ranges directed to the same component or property are inclusive of the endpoint and independently combinable (e.g., “about 5 wt % to about 20 wt %,” is inclusive of the endpoints and all intermediate values of the ranges of “about 5 wt. % to about 20 wt %,”). Reference throughout the specification to “one embodiment”, “another embodiment”, “an embodiment”, and so forth means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments. Unless defined otherwise, technical and scientific terms used herein have the same meaning as is commonly understood by one of skill in the art to which this invention belongs.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A defoaming composition comprising:
a carboxylic acid compound or an ester of a carboxylic acid;
an alpha olefin compound; and
an alcohol compound.

2. The defoaming composition of claim 1, wherein the alpha olefin compound comprises about 8 to about 36 carbon atoms and the alcohol compound comprises about 8 to about 36 carbon atoms.

3. The defoaming composition of claim 1, wherein the carboxylic acid compound comprises a saturated C₈ to C₂₄ carboxylic acid compound, an unsaturated C₈ to C₂₄ carboxylic acid compound, a C₁₈ to C₅₄ polycarboxylic acid, a C₈ to C₂₄ dicarboxylic acid compound, or a combination comprising at least one of the foregoing carboxylic acid compounds.

4. The defoaming composition of claim 1, wherein the alcohol compound comprises a straight chain fatty alcohol compound, a branched chain fatty alcohol compound, or a combination comprising at least one of the foregoing alcohol compounds.

5. The defoaming composition of claim 1, wherein the carboxylic acid compound or the ester of the carboxylic acid compound is at a concentration of about 5% to about 70% by weight of the defoaming composition, wherein the alpha olefin compound is at a concentration of about 20% to about 80% by weight of the defoaming composition, and wherein the alcohol compound is at a concentration of about 5% to about 50% by weight of the defoaming composition.

6. The defoaming composition of claim 1, wherein the alcohol compound is a solid at room temperature, and wherein the alpha olefin compound is present in an amount effective to solubilize the alcohol compound.

7. The defoaming composition of claim 1, being disposed on a substrate.

8. The defoaming composition of claim 1, having a biodegradability of greater than 70% after 28 days as measured in accordance with OECD Test Guideline Nos. 301A and 301E.

9. An end use material comprising the defoaming composition of claim 1 for reducing an amount of entrained gas present in the end use material.

10. The end use material of claim 9, being a wellbore treatment fluid, a cement composition, a drilling fluid composition, a waste treatment composition, a water treatment composition, a leaching solution for mining, a pulping composition, an oil and gas separation composition, a coating composition, a paper coating composition, or a paper composition.

11. A method for reducing an amount of entrained gas present in a flowable end use material, comprising: combining a defoaming composition with the fluid, the defoaming composition comprising:
a carboxylic acid compound or an ester of a carboxylic acid compound;
an alpha olefin compound; and
an alcohol compound.

12. The method of claim 11, wherein the alpha olefin compound comprises about 8 to about 36 carbon atoms and the alcohol comprises about 8 to about 36 carbon atoms.

13. The method of claim 11, wherein the carboxylic acid compound or the ester compound thereof comprises a saturated C₈ to C₂₄ carboxylic acid compound, an unsaturated C₈ to C₂₄ carboxylic acid compound, a C₁₈ to C₅₄ polycarboxylic acid, a C₈ to C₂₄ dicarboxylic acid compound, or a combination comprising at least one of the foregoing carboxylic acid compounds, and wherein the ester is a methyl ester.

14. The method of claim 11, wherein the alcohol compound comprises a straight chain fatty alcohol compound, a branched chain fatty alcohol compound, or a combination comprising at least one of the foregoing alcohol compounds.

15. The method of claim 11, wherein the carboxylic acid compound or the ester of the carboxylic acid compound is at a concentration of about 5% to about 70% by weight of the defoaming composition, wherein the alpha olefin compound is at a concentration of about 20% to about 80% by weight of the defoaming composition, and wherein the alcohol compound is at a concentration of about 5% to about 50% by weight of the defoaming composition.

16. The method of claim 11, wherein the alcohol compound is a solid at room temperature, and wherein the alpha olefin compound is present in an amount effective to solubilize the alcohol compound.

17. The method of claim 11, wherein the defoaming composition is disposed on a substrate.

18. The method of claim 112, wherein the end use material is a wellbore treatment fluid, a cement composition, a drilling fluid composition, a waste treatment composition, a water treatment composition, a leaching solution for mining, a pulping composition, a coating composition, a paper coating composition, or a paper composition.

19. A method for making a cement composition, comprising:
combining together a cementitious material, a fluid, and a defoaming composition comprising a carboxylic acid compound or an ester of a carboxylic acid compound an alpha olefin compound; and an alcohol compound.

20. The method of claim 19, wherein the alpha olefin compound comprises about 8 to about 36 carbon atoms and the alcohol compound comprises about 8 to about 36 carbon atoms.

21. The method of claim 19, wherein the carboxylic acid compound comprises a saturated C₈ to C₂₄ carboxylic acid compound, an unsaturated C₈ to C₂₄ carboxylic acid compound, a C₁₈ to C₅₄ polycarboxylic acid compound, a C₈ to C₂₄ dicarboxylic acid compound, or a combination comprising at least one of the foregoing carboxylic acid compounds.

22. The method of claim 19, wherein the alcohol compound comprises a straight chain fatty alcohol compound, a branched chain fatty alcohol compound, or a combination comprising at least one of the foregoing alcohol compounds.

23. The method of claim 19, wherein the carboxylic acid compound or the ester of the carboxylic acid compound is at a concentration of about 5% to about 70% by weight of the defoaming composition, wherein the alpha olefin compound is at a concentration of about 20% to about 80% by weight of the defoaming composition, and wherein the alcohol compound is at a concentration of about 5% to about 50% by weight of the defoaming composition.

24. The method of claim 19, wherein the alcohol compound is a solid at room temperature, and wherein the alpha olefin is present in an amount effective to solubilize the alcohol compound.

25. The method of claim 19, wherein the defoaming composition is disposed on a substrate.

25. A method of cementing in a subterranean formation, comprising:
displacing a cement composition into a subterranean formation, the cement composition comprising a carboxylic acid compound or an ester of a carboxylic acid compound; an alpha olefin compound; and an alcohol compound; and
allowing the cement composition to set.
